(19) United States
(12) Patent Application Publication
(10) Pub. No.: US 2026/0002609 A1
(43) Pub. Date: Jan. 1, 2026

(54) Drain Valve

(71) Applicant: Illinois Tool Works Inc., Glenview, IL (US)

(72) Inventors: Elliott Carter, Southam (GB); Emmanuel Ouine, Weinbourg (FR); Laurent Huet, Meru (FR)

(21) Appl. No.: 19/251,505

(22) Filed: Jun. 26, 2025

(30) Foreign Application Priority Data
Jun. 20, 2025 (DE) 10 2025 123 975.4
Dec. 16, 2024 (GB) 2418424.4
Jul. 1, 2024 (GB) 2409488.0

(51) Int. Cl. F16K 35/10

(52) U.S. Cl. CPC F16K 35/10

(57) ABSTRACT

The application relates to a drain valve comprising a cap and a cage. The cap includes at least one lock configured to cooperate with the cage to place the cap in locking engagement with the cage. A keeper is provided to interact with the lock of the cap to maintain the cap in locking engagement with the cage. One or more grips are arranged to secure the cage to a panel, and one or more lips are configured to resist passage of the cage through an aperture in the panel. The drain valve comprises at least one resilient seal.

### RELATED APPLICATIONS

The present application claims the benefit of British Patent Application No. 2409488.0, filed July 1, 2024, British Patent Application No. 2418424.4, filed December 16, 2024, and German Patent Application No. 102025123975.4, filed June 20, 2025, each titled "Drain Valve," the contents of which are hereby incorporated by reference.

### TECHNICAL FIELD

The disclosure relates to a drain valve comprising a cap and a cage.

### BACKGROUND

As the design of vehicles changes with the uptake of electric transmission systems, new design opportunities arise. The removal of internal combustion engines from vehicles has seen an increase in provision of front luggage areas, i.e. Front trunks or "frunks".

Frunks are often tub-like in shape comprising walls and a base which form a depression. Using this type of space presents some interesting design opportunities. Uses of the funk can include wet uses, where the frunk is filled with liquids or other substances which would be unsuitable for storage elsewhere in the vehicle (such as ice). Frunk users may enjoy the opportunity to fill the frunk with a liquid for example. However, this presents the problem of how to remove the liquid from the frunk safely with regard to isolating the liquid from the vehicle electrics and also user convenience.

Water based liquids are heavy so a liner for a user to lift from the funk and remove to a remote location to pour away the liquid is not feasible. While a drain may be provided, a closure must be provided to prevent leakage of liquid in the frunk out of the closure prematurely and also to prevent environmental ingress from the outside and into the frunk via the drain.

### SUMMARY OF THE DISCLOSURE

The present disclosure relates generally to a drain valve, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a drain valve.

FIG. 2 illustrates an exploded view of a drain valve and panel.

FIGS. 3A and 3B illustrate a drain valve in, respectively, a closed configuration and an open configuration.

FIGS. 4A and 4B illustrate, respectively, an underside perspective view of a drain valve fitted to a panel and a top-side perspective view of a drain valve fitted to a panel.

FIGS. 5A, 5B, and 5C illustrate an alternative drain valve in, respectively, underside closed, top side closed, and side view open views.

FIGS. 6A and 6B illustrate an alternative drain valve in exploded view with, respectively, a cage and a cap.

FIGS. 7A and 7B illustrate an alternative drain valve in exploded view with, respectively, a cage and a cap.

FIGS. 8A and 8B illustrate an alternative drain valve in exploded view with, respectively, cage and a cap.

FIGS. 9A and 9B illustrate an alternative drain valve in exploded view with, respectively, a cage and a cap.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as "first," "second," "top," "bottom," "side," "front," "back," and the like are words of convenience and are not to be construed as limiting terms. For example, while in some examples a first side is located adjacent to or near a second side, the terms "first side" and "second side" do not imply any specific order in which the sides are ordered.

The terms "about," "approximately," "substantially," or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language ("e.g.," "such as," or the like) provided herein, is intended merely to better illuminate the disclosed examples and does not pose a limitation on the scope of the disclosure. The terms "e.g.," and "for example" set off lists of one or more non-limiting examples, instances, or illustrations. No language in the specification should be construed as indicating any unclaimed element as essential to the practice of the disclosed examples.

The term "processor" means processing devices, apparatuses, programs, circuits, components, systems, and subsystems, whether implemented in hardware, tangibly embodied software, or both, and whether or not it is programmable. The term "processor" as used herein includes, but is not limited to, one or more computing devices, hardwired circuits, signal- modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC). The processor may be coupled to or integrated with a memory device. The memory device can be any suitable type of computer memory or any other type of electronic storage medium, such as, for example, read-only memory (ROM), random access memory (RAM), cache memory, compact disc read-only memory (CD-ROM), electro-optical memory, magneto-optical memory, programmable read-only memory (PROM), erasable programmable read-only memory (EPROM), electrically erasable programmable read-only memory (EEPROM), a computer- readable medium, or the like.

The term "and/or" means any one or more of the items in the list joined by "and/or." As an example, "x and/or y" means any element of the three-element set {(x), (y), (x, y)}. In other words, "x and/or y" means "one or both of x and y." As another example, "x, y, and/or z" means any element of the seven-element set {(x), (y), (z), (x, y), (x, z), (y, z), (x, y, z)}. In other words, "x, y, and/or z" means "one or more of x, y, and z."

According to the disclosure there is provided a drain valve comprising a cap and a cage, wherein the cap comprises at least one lock arranged to cooperate with the cage to place the cap in a locking engagement with the cage. The cage comprises a keeper arranged to cooperate with the lock of the cap to hold the cap in a locking engagement with the cage. One or more grips are arranged to secure the cage to a panel. One or more lips are arranged to resist the passage of the cage through a panel aperture. The drain valve further comprises at least one resilient seal. The drain valve allows for excess or otherwise unwanted liquids to be drained from a cargo hold of a vehicle at will be a user. The cage allows the drain valve to be readily installed, preferably, by push-fit, into a panel of the vehicle without the use of additional fixations. The drain valve is intended to be self-sealing, thereby also not requiring any additional sealing to prevent the passage of liquids across the drain valve (in either direction, ingress or egress).

Preferably, the at least one resilient seal is at least one resilient skirt and arranged on the cap. The at least one resilient skirt is configured to, in use, form a fluid tight seal with the cage and/or with a panel. The skirt may form an over seal for the entire drain valve, thereby sealing directly with the panel. In this case the cage may not be provided with any sealing means. If the skirt seals against the cage, additional sealing between the cage and the panel may be used to prevent fluid leakage.

Suitably, the resilient skirt, when forming a fluid tight seal with a panel, is sized to form the fluid tight seal over a cage in order to provide a complete over-seal.

At least one resilient seal is provided on the cage. Further optionally, at least one gasket is provided on the cage and arranged to form a fluid tight seal between the cage and a panel.

Preferably, the cap further comprises one or more anti-tipping ribs in order to assist location of the cap within the cage to prevent cross threading or otherwise improper seating of the cap within the cage which may impair the function of the drain valve. The anti-tipping ribs ensure the parts of the lock and keeper correctly align.

Suitably, the at least one lock is operated by rotation of the cap, and optionally or alternatively wherein the lock comprises a screw thread or a bayonet fixing, and further optionally or alternatively, wherein the lock is fully operably by a rotation in the range of 180 degrees to 360 degrees. The range of 180 degrees to 360 degrees ensures that a sufficiently large movement is required to operate to drain valve to prevent accidental operation and also to provide confidence to the user that they have correctly operated the drain valve. The movement is limited though so as to not require an excess of movement for a successful operation as well as to minimize the risk of the drain valve not being fully closed or opened by a user.

The keeper comprises one or more trapping positions arranged to maintain a position of the cap relative to the cage, the position selected from an open drain valve position, a closed drain valve position, or a partially opened drain valve position. In this way, the position of the drain valve may be intentionally set by a user and confidence provided that the drain valve will remain in that position (e.g. Left open to allow the void within the vehicle to fully dry).

Preferably, the grips comprise one or more resilient legs arranged to resist the cage passing through the panel aperture in a direction opposite to a direction of movement resisted by the one or more lips. This provides a secure attachment of the cage to a panel.

Suitably, the lock and cap are provided with respective, complementary locators, and optionally wherein the complementary locators translate with respect to one another, and further optionally wherein the complementary locators allow the lock and cap to be spaced apart, while without a pitch or roll rotation of either part. The complementary locators function similarly to the anti-tipping ribs to ensure correct alignment and performance of the parts of the drain valve as discussed above. Here pitch and roll refer to rotation modes of movement through space. The cap may remain able to make movements in a yaw direction in order to, for example, rotate the cap to engage with elements of the cage, but to maintain a position in the pitch and roll directions (to ensure the parts mate correctly).

The complementary locators are arranged to interact with each other prior to the other features of the cap and lock, when the cap is first introduced to the lock, and further optionally or alternatively, wherein a first of the complementary locators comprises a peg and a second of the complementary locators comprises a tunnel.

Preferably, the cap is fully removable from the cage, or, alternatively, wherein the cap is captured by the cage. When fully removable, the cap may be replaced and/or serviced. When captured, the cap is loosely retained adjacent the cage to ensure the cap cannot be misplaced and is always present for use.

According to the disclosure there is provided a cap for a drain valve comprising at least one lock arranged to cooperate with a cage to place the cap in a locking engagement with the cage, and at least one resilient skirt arranged to, in use, form a fluid tight seal with a panel, wherein the resilient skirt is sized to form the fluid tight seal over a cage. The skirt forms a fluid tight seal between the cap and the panel sufficient to prevent passage of fluid (typically liquid) from one side of the panel to the other side of the panel.

Preferably, the at least one lock is operated by rotation of the cap.

According to the disclosure, there is provided a cage for a drain valve comprising a keeper arranged to cooperate with a lock of a cap, of the disclosure, to hold the cap in a locking engagement with the cage, one or more grips arranged to secure the cage to a panel, and one or more lips arranged to resist the passage of the cage through a panel aperture.

Suitably, the keeper comprises one or more trapping positions arranged to maintain a position of the cap relative to the cage, the position selected from an open drain valve position, a closed drain valve position, or a partially opened drain valve position.

The grips comprise one or more resilient legs arranged to resist the cage passing through the panel aperture in a direction opposite to a direction of movement resisted by the one or more lips.

According to the disclosure there is provided a drain valve comprising the disclosed cap and the disclosed cage.

According to the disclosure there, is provided a vehicle comprising any of the aforesaid drain valves, and/or cages. The vehicle may possess either or both of a frunk or a trunk (boot), or other cargo hold, and the drain valve and/or at least the cage may be located within the frunk, trunk, or other cargo hold and optionally arranged such as to provide a drainage function of an excess of liquid within the vehicle.

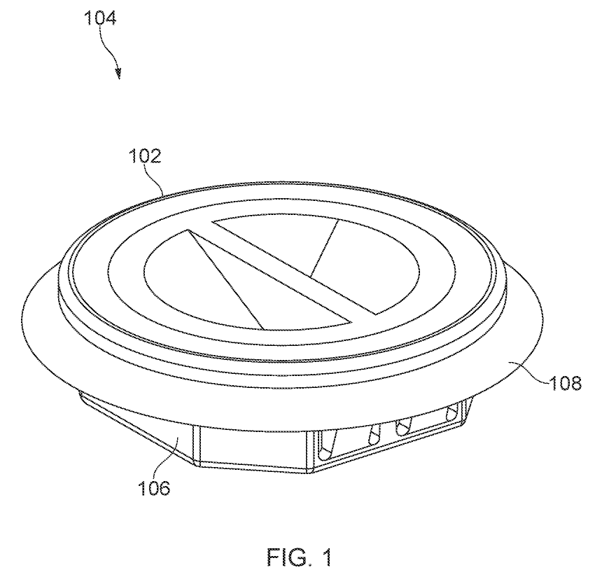

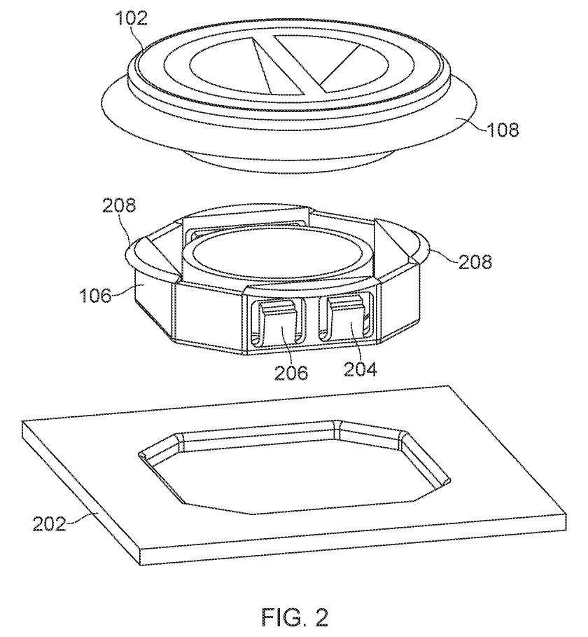

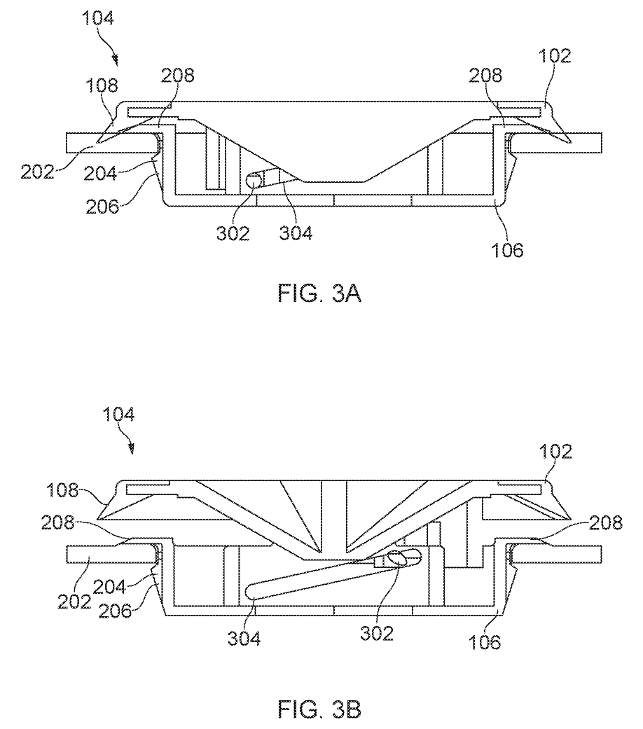

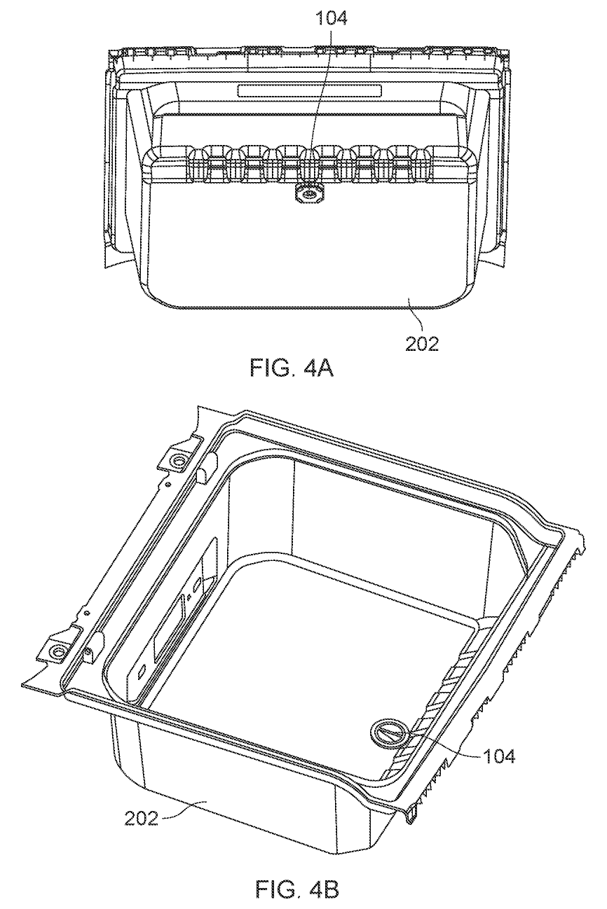

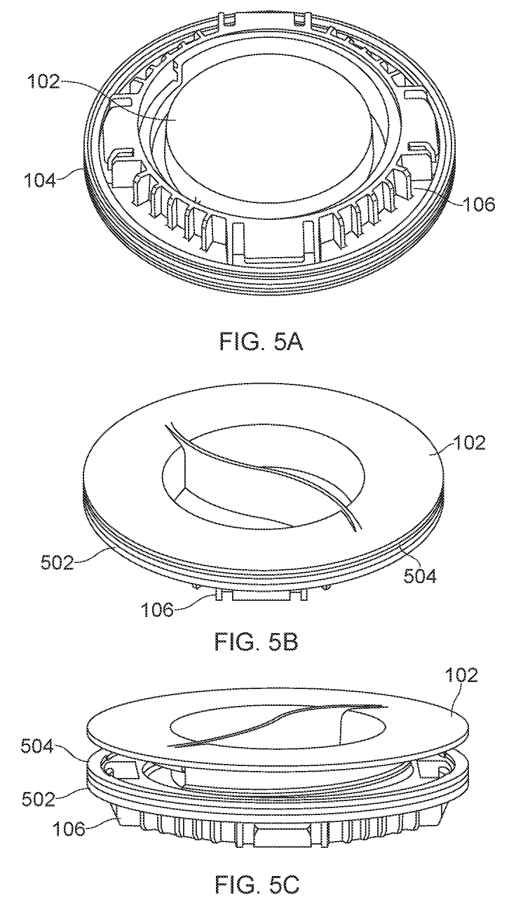

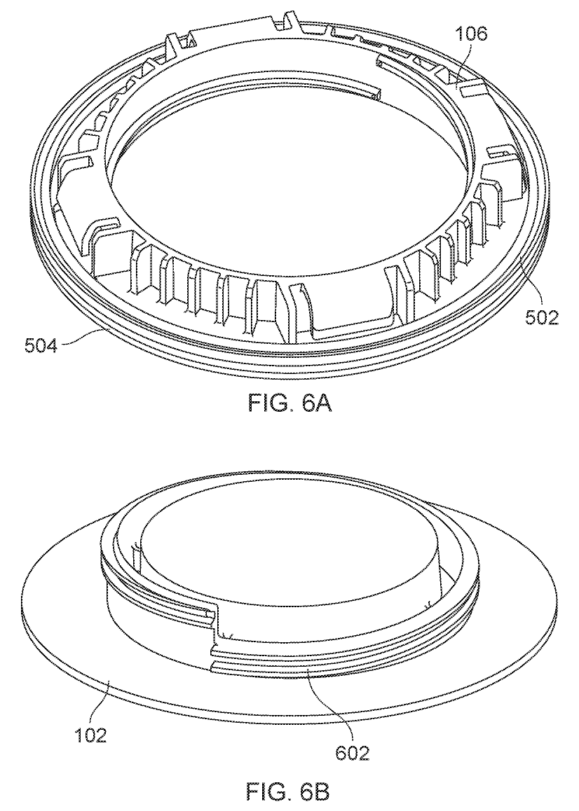

FIGS. 1 through 9B illustrate various embodiments and views of drain valve assemblies. FIG. 1 shows a drain valve in isolation, while FIG. 2 provides an exploded view of a drain valve and its associated panel. FIGS. 3A and 3B depict the valve in closed and open configurations, respectively. FIGS. 4A and 4B present perspective views of the valve installed on a panel, showing both underside and top-side orientations. FIGS. 5A-5C illustrate an alternative valve design in underside closed, top-side closed, and side open views. FIGS. 6A-9B show additional alternative drain valve embodiments, each in exploded views with respective cages and caps, providing different structural configurations across the figures.

In FIG. 1 there is shown a drain valve 104 which allows fluid (such as water) to pass from one side of the drain valve 104 to an opposite side of the drain valve 104 upon the will of a user.

This is achieved via a cap 102 which the user can partially or fully remove from the drain valve 104. The cap 102 closes a passageway through which fluid may flow.

The cap 102 has a skirt 108. The skirt 108 provides a seal between the whole drain valve 104 and the surface to which the drain valve 104 is fitted (typically the panel 202 of a vehicle).

A cage 106 is provided which provides a structure into which the passageway may be formed as well as providing fixations to hold the drain valve 104 in a fixed relationship with the panel 202. The cap 102 interacts with the cage 106 to provide a sealing closure or partial closure.

As the skirt 108 of the cap 102 provides a seal for the whole drain valve 104, including the cage 106 no additional seals are required (though such auxiliary seals may be provided), the drain valve 104 may be provided to a vehicle manufacturer as a single unit that is readily installed. The only action required to provide an effective drain valve 104 in the panel 202 of a vehicle that is capable of preventing unintentional passage of a fluid is to insert the cage 106 into the panel 202 so that the skirt 108 is urged towards the panel 202 (the cap 102 is attached to the cage 106 during installation in a closed position) in order to form an effective seal.

Typical full sealing of fluid can be provided for 300mm depth of fluid for 2 hours in both directions across the drain valve 104 although this may be varied depending on the requirements of the drain valve 104. The passageway may be sized to permit fast flow 1OL/min draining, although it will be apparent that this is varied by changing the size of the passageway. Any suitable size passageway may be used provided the skirt 108 is also changed in size to accommodate the passageway.

As the cage 106 sits within a panel 202 and the cap 102 sits within the cage 106, a low stand-off height (i.e. The distance the drain valve 104 protrudes in a direction perpendicular to a main plane of the panel 202) for the drain valve 104 is achieved.

The cap 102 may be provided with a finger grip to provide an ergonomic handle for an and user to operate the drain valve 104. The drain valve 104 may be actuated by any suitable movement, but is typically rotated between the open, closed, or indeterminate position. The rotation occurs parallel to a main plane of the panel 202 (i.e. The axis of rotation is perpendicular to the main plane of the 202). Twisting the cap 102 counter-clockwise, for example, may raise the cap 102 relative to the cage 106 and opens the drain valve 104 for the fluid to drain.

Twisting the dial clockwise may, for example, lower the cap 102 relative to the cage 106 and tensions the skirt 108 against the panel 202 to form a fluid tight seal.

The cap 102 may be fully removable to allow an end user to clean or remove obstructions from the drain valve 104.

With reference to FIG. 2 there is shown an exploded view of the drain valve 104. The features of the cage 106 are clearly visible. Lips 208 are provided on the cage 106 and arranged to abut with the panel 202 and prevent the cage 106 from passing through an aperture in the panel 202. Any suitable number of lips 208 may be used from one lip or multiple lips 208. A single lip 208 can be continuous about a perimeter of the cage 106 or may partially run the perimeter of the cage 106. Where there are multiple lips 208, these may be arranged at any suitable point along the perimeter of the 106, such as equidistant, or on opposing sides where the cage 106 has a cross section which describes a polygon (alternatively the cage 106 may define a circular cross section). The lips 208 prevent an operative from over-pushing the drain valve 104 during installation and ensures the drain valve 104 is easy to fit.

Opposed to the lips 208 are provided one or more grips 204, which are arranged to grip a side of the panel 202 which is opposite to the side abutted by the lips 208. In this way, during installation of the drain valve 104 the panel 202 is pinched or caught between the lips 208 and the resilient legs 206, which ensures that the drain valve 104 is securely attached to the panel 202.

The grips 204 may take the form of resilient legs 206 such that the drain valve 104 has a snap-fit with the panel 202. The distance between the grips 204 and the lips 208 may correspond to the thickness (i.e. Distance between opposing surfaces) of the panel 202. Alternatively, one or both of the lips 208 or grips 204 may be provided with a ramped surface in order to accommodate multiple panel 202 thicknesses or variations in thickness within the same panel 202.

As per the lips 208 the resilient legs 206 may be locations at any suitable location about the perimeter of the cage 106, such as equidistant, or on opposing sides where the cage 106 has a cross section which describes a polygon (alternatively the cage 106 may define a circular cross section).

The grips 204 may be located substantially opposite the lips 208 so the grips 204 and lips 208 function with synergy to pinch a panel 202 therebetween. Alternatively, the lips 208 and grips 204 may be offset from one another, or a mixture of these two arrangements may be used provided a secure fixation to the panel 202 may be achieved by the cage 106.

With reference to FIG. 3A there is shown a cross section of the drain valve 104 in a closed position with the skirt 108 in sealing engagement with the panel 202.

The lips 208 of the cage 106 are in abutting engagement with the panel 202 and the grips 204 are provided opposite the lips 208 in this instance in order to provide a pinching clasp of the panel 202 by the cage 106.

As can be seen in the figure, the cage 106 is provided with a keeper 304 which takes the form of a track or slot. In the keeper 304 runs a lock 302 of the cap 102. The keeper 304 retains the lock 302 and prevents unintentional disassociate of the cap 102 from the cage 106. It will be apparent that this arrangement may be switched with the cage 106 comprising the lock 302 and the cap 102 comprising the keeper 304. Multiple locks 302 and keepers 304 may be provided one or both of the cap 102 and cages 106. There need not be a complementary lock 302 for every keeper 304 and vice versa, this may be to ensure that the cap 102 can be attached to the cage 106 in multiple locations or to provide redundancy. Alternatively, the lock and keeper can be any suitable mechanism including complementary screw threads, pop-up plug, click-clack plug, or the like provided the function of moving the cap and cage between open and closed positions, and intermediate positions if needed, is preserved.

The keeper 304 may be provided with one or more trapping positions (not shown) in the form of wells or depressions along the track. The lock 302 when passing over such a trapping position is retained in the trapping positions and thereby halting continued movement of the caps 102 and fixing the relative position of the cap 102 to the cage 106. Trapping positions may be provided at the closed position or the open position, thereby holding the drain valve 104 in the closed or open position respectively. Trapping positions may be provided at intermediate locations along the keeper 304 such that the drain valve 104 is held in a position indeterminate between fully open and fully closed. Such a position may be useful for controlling the flow of fluid through the drain valve 104 or the type of fluid (liquid compared to gas). A semi-open position may be useful to allow the flow of air to ensure the area drained by the drain valve 104 (frunk) has a flow of air to allow for drying or exhaust of odors.

FIG. 3B shows the drain valve 104 in the open position with the skirt 108 placed remote from the panel 202 thereby allowing fluid through the passageway of the drain valve 104 and through to the opposing side of the panel 202. The lock 302 is still shown in the track of the keeper 304. The keeper 304 may be provided with an escape portion which allows the lock 302 to escape the track, and thereby the cap 102 to be fully removed and placed remote from the cage 106.

FIG. 4A and B show perspective views of a panel 202 with a drain valve 104 in place. The panel 202 may form part of a frunk. The funk may be designed such that the drain valve 104 is located in a position which, in the vehicle, is closer to the ground than other areas of the frunk such that liquids settle adjacent the drain valve 104 to allow easy draining.

FIGS. 5A, SB, and SC show an alternative drain valve 104 with many similarities to the drain valves shown in FIG. 1 to FIG. 4B, with like elements provided with the same numerals so as not to unnecessarily repeat the description. The drain valve 104 of FIGS. SA, SB, and SC differs in the resilient skirt 504. The skirt is provided on the cage 106 and forms a fluid tight seal between the cap and the cage. A further gasket 502 is provided on a face of the cage which seals with the panel, to provide a fluid tight seal therebetween.

FIGS. 6A and 6B show a possible lock for the cap. The lock comprises a screw thread 602 which requires a 360° rotation of the cap to move the drain valve between a closed position and an open position.

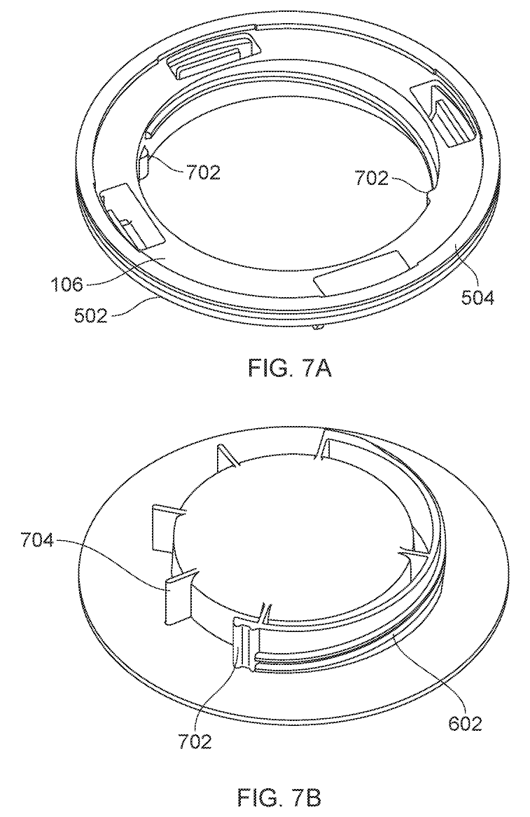

FIGS. 7A and 7B show an alternative possible lock for the cap. The lock comprises a screw thread 602 which requires a 1800 rotation of the cap to move the drain valve between a closed position and an open position. It is noted any degree of rotation may be selected, however those presented here are considered useful in order for a user to have a reassuring operation of the drain valve. As the cap is unsupported by the screw thread, anti-tipping ribs 704 are provided to prevent rocking of the cap within the cage. A 1800 turning thread is also advantageous as additional volume of fluid may pass through the drain valve compared to the cap having a 3600 thread. The thread of the 1800 version need only partially surround the cap compared to the 3600 version.

Trapping positions 702 are also provided on the cap to hold the position of the cap in a certain position (i.e. Open or closed). The trapping positions 702 are formed of a pair of ridges which are arranged to snap fit with corresponding trapping positions 702 of the cage (also ridges).

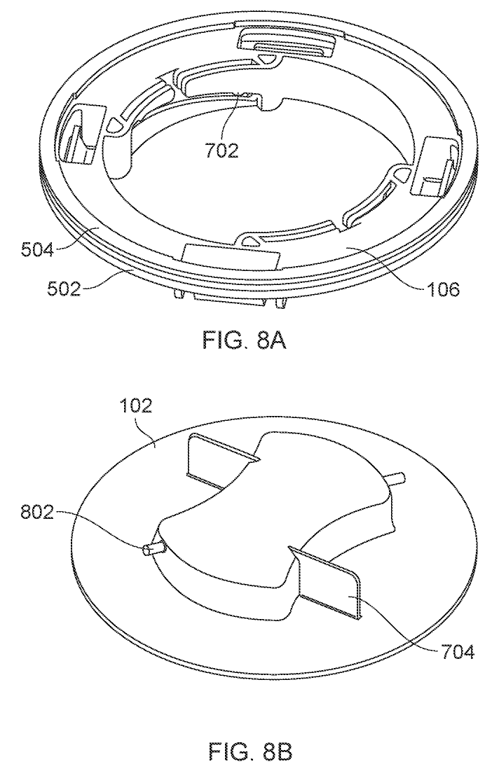

FIGS. 8A and 8B show an alternative possible lock for the cap. The lock comprises a bayonet fixing 802 to move the drain valve between a closed position and an open position. As the cap is unsupported by the screw thread, anti-tipping ribs 704 are provided to prevent rocking of the cap within the cage. Trapping positions 702 are provided similarly to that shown in FIGS. 7A and 7B.

The gasket 502 as presented in any of the above drain valves may be formed of any suitable material for forming a fluid light seal between the parts. Likewise, as the skirt. The skirt and gasket may be formed of the same or different materials, such as, but not limited to, a silicone or rubber.

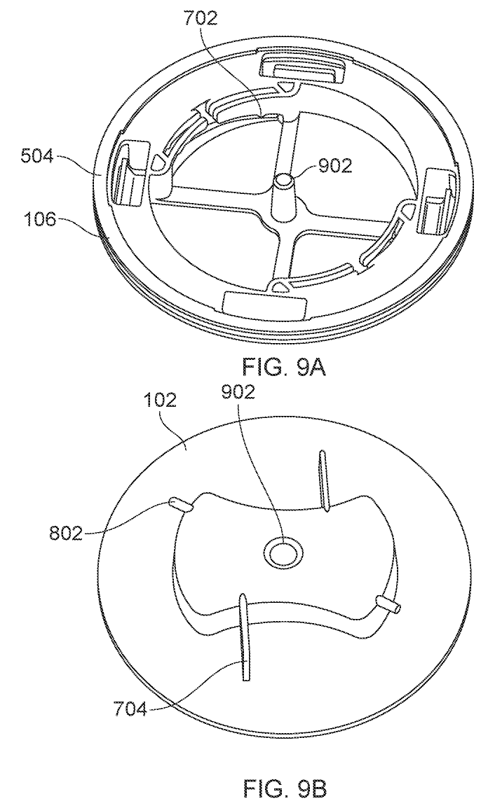

FIGS. 9A and 9B show a further alternative possible lock and cap, similar to that shown in FIGS. 8A and 8B, i.e. Comprising a bayonet fixing 802. Like reference numerals are provided for like features to avoid unnecessary repetition. The lock and cap of FIGS. 9A and 9B differ in the provision of complementary locators 902 on each of the cap 102 and cage 106 which can be, e.g. A peg and a blind tunnel in which the peg may travel (translate along). The idea is that the complementary locators 902 provide additional stability when arranging the drain valve 104 in the open position. As, in the open position, the cap 102 is relatively remote from the cage 106 compared to the closed position, the cap 102 may feel unstable or rock relative to the cage 106. Providing complementary locators 902 provides a stabilizing means to prevent this undesirable movement. Preferable, the complementary locators 902 engage sufficiently early when arranging the pieces together, and/or have sufficient travel, for the stabilizing effect to be provided throughout the travel of the cap 102 relative to the cage 106 all the way from the open position to the closed position.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words "comprise" and "contain" and variations of them mean "including but not limited to", and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A drain valve comprising
a cap (102), wherein the cap (102) comprises at least one lock (302) arranged to cooperate with the cage (106) to place the cap (102) in a locking engagement with the cage (106); and
a cage (106) having:
a keeper (304) arranged to cooperate with the lock (302) of the cap (102) to hold the cap (102) in a locking engagement with the cage (106),
one or more grips (204) arranged to secure the cage (106) to a panel (202), and
one or more lips (208) arranged to resist the passage of the cage (106) through a panel (202) aperture, wherein the drain valve (104) further comprises at least one resilient seal.

2. The drain valve (104) of claim 1, wherein the at least one resilient seal is at least one resilient skirt (108) arranged on the cap (102), and configured to, in use, form a fluid tight seal with the cage (106) and/or with a panel (202).

3. The drain valve (104) of claim 2, wherein the resilient skirt (108), when forming a fluid tight seal with a panel (202), is sized to form the fluid tight seal over a cage (106), and optionally, or alternatively,
wherein the at least one resilient seal is provided on the cage, and further optionally
wherein at least one gasket is provided on the cage and arranged to form a fluid tight seal between the cage and a panel.

4. The drain valve (104) of claim 1, wherein the cap further comprises one or more anti-tipping ribs (704).

5. The drain valve (104) of claim 1, wherein the at least one lock (302) is operated by rotation of the cap (102), and optionally or alternatively wherein the lock (302) comprises a screw thread or a bayonet fixing, and further optionally or alternatively, wherein the lock (302) is fully operably by a rotation in the range of 180 degrees to 360 degrees.

6. The drain valve (104) of claim , wherein the keeper (304) comprises one or more trapping positions arranged to maintain a position of the cap relative to the cage, the position selected from an open drain valve position, a closed drain valve position, or a partially opened drain valve position.

7. The drain valve (104) of claim 1, wherein the grips comprise one or more resilient legs arranged to resist the cage passing through the panel aperture in a direction opposite to a direction of movement resisted by the one or more lips.

8. The drain valve of claim 1, wherein the lock (302) and cap (102) are provided with respective, complementary locators (902), and optionally wherein the complementary locators (902) translate with respect to one another, and further optionally wherein the complementary locators (902) allow the lock (302) and cap (102) to be spaced apart without a pitch or roll rotation of either part.

9. The drain valve of claim 8, wherein the complementary locators (902) are arranged to interact with each other prior to the other features of the cap (102) and lock (302), when the cap (102) is first introduced to the lock (302), and further optionally or alternatively, wherein a first of the complementary locators (902) comprises a peg and a second of the complementary locators (902) comprises a tunnel.

10. The drain valve of claim 1, wherein the cap (102) is fully removable from the cage (106), or, alternatively, wherein the cap (102) is captured by the cage (106).
